(19) United States
(12) Patent Application Publication
(10) Pub. No.: US 2025/0305620 A1
(43) Pub. Date: Oct. 2, 2025

(54) THERMALLY RETARDED STRUCTURES FOR COMPONENTS APPLIED IN HIGH TEMPERATURE ENVIRONMENTS AND METHODS OF MANUFACTURING THE SAME

(71) Applicant: AGENCY FOR DEFENSE DEVELOPMENT, Daejeon (KR)

(72) Inventors: Yeon Gwan LEE, Daejeon (KR); Min Soo JANG, Daejeon (KR); Bon Woong GOO, Daejeon (KR); Cheong Hee YOO, Daejeon (KR); Heeseung PARK, Daejeon (KR)

(21) Appl. No.: 19/091,427

(22) Filed: Mar. 26, 2025

(30) Foreign Application Priority Data
Mar. 27, 2024 (KR) 10-2024-0041809

(51) Int. Cl. F16L 59/02; B33Y 80/00; F16C 3/02

(52) U.S. Cl. CPC F16L 59/029; B33Y 80/00; F16C 3/02; F16C 2220/02

(57) ABSTRACT

The purpose of the present disclosure is to provide a thermally retarded structure for components applied in high temperature environments and a method for manufacturing the same, which delays the heat transfer to the drive unit. Provided is a thermally retarded structure for components applied in high temperature environments, comprising: a drive shaft body into which a heat source is introduced; a heat retarding unit including a plurality of heat retarding layers having a pore structure and a filling layer formed between the plurality of heat-retarding layers to facilitate heat transfer, wherein each of the plurality of heat retarding layers is spaced apart from one another in correspondence with a direction in which the heat source is introduced into the drive shaft body; and a drive connection part axially connected to the heat retarding unit.

### CROSS-REFERENCE TO RELATED APPLICATION

This application claims priority to Korean Patent Application No. 10-2024-0041809 filed on Mar. 27, 2024, and all the benefits accruing therefrom under 35 U.S.C. § 119, the contents of which are incorporated by reference in its entirety.

### BACKGROUND OF THE DISCLOSURE

### 1. Field of the Disclosure

The present disclosure relates to a thermally retarded structure for components applied in high temperature environments and a method for manufacturing the thermally retarded structure. In particular, the present disclosure pertains to a thermally retarded structure for components and a manufacturing method thereof, which ensure the structural rigidity of structures or components operating in high temperature environments, such as those used in the defense industry, and delay heat transfer to the drive unit to prevent operational errors caused by material property degradation.

### 2. Description of the Related Art

In high temperature environments, such as those involving projectiles, including missiles or rockets in the defense industry, the material properties may degrade, leading to a reduction in strength, an increase in ductility, or thermal expansion, all of which can affect structural stability.

Therefore, the deterioration of component materials can result in deformation, damage, or failure of the structure, particularly impacting the precision attitude control capability of components such as lateral thrusters used for the attitude control of projectiles.

In addition, during the operation of a projectile, repeated thermal cycling between high temperatures and ambient temperatures can induce material fatigue, potentially causing the formation of microcracks within the material, which may gradually propagate. The expansion of such microcracks due to fatigue can ultimately lead to structural failure, posing a serious threat to the safety and reliability of the projectile.

Since these factors directly affect the stable operation and mission performance of projectiles exposed to high-temperature environments, there is a growing demand for the development of heat transfer delaying structures to protect components and maintain performance in such conditions.

In particular, for internal drive structures operating in high-temperature and high-pressure environments, such as lateral thrusters responsible for the attitude control of projectiles, there is required a component structure that ensures high-temperature structural rigidity, prevents seizure in drive bearings, and withstands exposure to high pressure flame gases while maintaining rigidity.

### RELATED PATENT DOCUMENT

(Patent Document 1) Korean Registered Patent No. 10-1436144 (Sep. 1, 2014)
(Patent Document 2) Korean Patent Publication No. 10-2023-0095036 (Jun. 28, 2023)

### SUMMARY OF THE DISCLOSURE

In order to solve out the aforementioned conventional problems, the purpose of the present disclosure is to provide a thermally retarded structure for components applied in high temperature environments and a method for manufacturing the same, which ensures the structural rigidity of structures or components operating in high temperature environments and delays the heat transfer to the drive unit, thereby preventing seizure due to thermal expansion during the required operation time.

In addition, another purpose of the present disclosure is to allow the application direction of the thermally retarded structure to vary depending on whether the primary heat transfer path is from the external environment or through the interior of the structure. This enables the structure to maintain structural rigidity even in high temperature environments, minimizing deformation of the exterior while also delaying the reduction of structural strength.

In addition, the present disclosure aims to provide a thermally retarded structure and the manufacturing method that plays a crucial role in achieving the target performance of components used in structures exposed to high temperatures for short durations, by even slightly delaying heat transfer in terms of strength and rigidity.

Furthermore, the present disclosure aims to provide a thermally retarded structure and the manufacturing method, which cannot be fabricated through conventional machining but can be realized using 3D printing processes.

In order to achieve the purpose, an aspect of the present disclosure provides a thermally retarded structure for components applied in high temperature environments, the thermally retarded structure comprising: a drive shaft body into which a heat source is introduced; a heat retarding unit including a plurality of heat retarding layers having a pore structure and a filling layer formed between the plurality of heat-retarding layers to facilitate heat transfer, wherein each of the plurality of heat retarding layers is spaced apart from one another in correspondence with a direction in which the heat source is introduced into the drive shaft body; and a drive connection part axially connected to the heat retarding unit.

In some exemplary embodiments, the drive connection unit may be a bearing assembly unit configured to operate with a bearing.

In some exemplary embodiments, the thermally retarded structure may be an internal drive structure of a lateral thruster responsible for attitude control of a projectile.

In some exemplary embodiments, the heat retarding layer may include: a pore structure pattern having a pre-designed shape; and a pattern reinforcement structure configured to enhance the rigidity of the heat retarding layer.

In some exemplary embodiments, the pore structure pattern may be designed based on at least one design element selected from a group consisting of material, stacking order, shape, pattern size, outer wall thickness, and single pattern height, in order to correspond to a pre-designed heat transfer distance and structural rigidity.

In some exemplary embodiments, the heat retarding layer and the filling layer may be formed by stacking in a direction of a drive shaft using a 3D printing technique.

In some exemplary embodiments, the heat retarding layer and the filling layer may be stacked using the 3D printing technique, and stacking order, spacing, shape, size, and thickness of the heat retarding layer and the filling layer may be designed to correspond to a pre-determined structural rigidity of the drive shaft.

In addition, in order to achieve the purpose, another aspect of the present disclosure provides a method of manufacturing a thermally retarded structure for components applied in high temperature environments based on a 3D printing technique, the method comprising steps of: (a) stacking a drive shaft body into which a heat source is introduced; (b) forming a heat retarding unit including a plurality of heat retarding layers having a pore structure and a filling layer formed between the plurality of heat-retarding layers to facilitate heat transfer, wherein each of the plurality of heat retarding layers is spaced apart from one another in correspondence with a direction in which the heat source is introduced into the drive shaft body, and wherein the heat retarding unit is formed by alternately stacking each of the plurality of heat retarding layers with a pore structure pattern and the filling layer inside the drive shaft body; and (c) forming a drive connection unit in an axial direction at an upper portion of the heat retarding unit.

In some exemplary embodiments, the step (b) may comprise steps of: (b1) stacking the filling layer in an axial direction at an upper portion of the drive shaft body; (b2) stacking the heat retarding layer including the pore structure pattern and a pattern reinforcement structure at an upper portion of the filling layer; and (b3) repeating the steps (b1) and (b2) to form the heat retarding unit in which the filling layer constitutes an end portion of the heat retarding unit.

In some exemplary embodiments, in the step (b), the heat retarding layer and the filling layer may be stacked using the 3D printing technique to form the heat retarding unit, and stacking order, number, spacing, shape, size, and thickness of the heat retarding layer and the filling layer may be designed to correspond to a pre-determined structural rigidity of the drive shaft.

In some exemplary embodiments, the pore structure pattern may be designed based on at least one design element selected from a group consisting of material, stacking order, shape, pattern size, outer wall thickness, and single pattern height, in order to correspond to a pre-designed heat transfer distance and structural rigidity.

In addition, still another aspect of the present disclosure provides a thermally retarded structure for components applied in high temperature environments, characterized by being manufactured by the aforementioned method.

In some exemplary embodiments, the thermally retarded structure may be used in an internal drive structure of a lateral thruster responsible for attitude control of a projectile.

Specific details of other exemplary embodiments are included in “Details for carrying out the invention” and accompanying “drawings”.

Advantages and/or features of the present disclosure, and a method for achieving the advantages and/or features will become obvious with reference to various exemplary embodiments to be described below in detail together with the accompanying drawings.

However, the present disclosure is not limited only to a configuration of each exemplary embodiment disclosed below, but may also be implemented in various different forms. The respective exemplary embodiments disclosed in this specification are provided only to complete disclosure of the present disclosure and to fully provide those skilled in the art to which the present disclosure pertains with the category of the present disclosure, and the present disclosure will be defined only by the scope of each claim of the claims.

According to the present disclosure, the structural rigidity of structures or components operating in high temperature environments can be ensured, while delaying heat conduction to drive units such as bearing mounting sections, thereby preventing seizure due to thermal expansion in the bearing mounting section.

In addition, the present disclosure allows the application direction of the thermally retarded structure to vary depending on whether the primary heat transfer path is from the external environment or through the interior, ensuring structural rigidity even in high temperature environments. This minimizes deformation of the exterior and delays the reduction of structural strength, thereby providing a thermally retarded structure for components and a method for manufacturing the same.

Furthermore, the present disclosure increases the length of the heat transfer path, effectively delaying the time it takes for heat to reach heat sensitive components. When applied to projectiles, the thermally retarded structure according to the present disclosure can be particularly useful for missile and projectile systems, which experience rapid temperature changes during launch or flight.

Moreover, by integrating low thermal conductivity materials into the thermally retarded structure, the present disclosure minimizes the rate at which heat flows into critical components, ensuring that they operate within their temperature tolerance limits.

In addition, incorporating the pattern reinforcement structure within the heat retarding layer not only improves thermal management but also enhances the mechanical strength of the components. This dual functionality makes the disclosed technology highly useful in the defense industry, where components are subjected to extreme operational stresses beyond simple thermal loads.

The present disclosure also enables the design of thermally retarded structure with specific materials, shapes, and layer configurations, allowing for the optimization of thermal and structural properties to meet the unique requirements of each application.

By utilizing 3D printing technology, the present disclosure enables the fabrication of complex geometries that would be difficult or impossible to achieve using conventional manufacturing methods. This also ensures the precision required for defense components, where every detail can impact performance and reliability.

Furthermore, through the manufacturing process, the material composition, thickness, and shape of each layer can be finely controlled. This level of customization is highly effective in tuning the thermal and mechanical properties of components to meet specific operational requirements.

By applying 3D printing technology, the present disclosure also minimizes material waste, as additive manufacturing only uses material where needed, unlike subtractive manufacturing. This is particularly advantageous when using expensive materials commonly found in the defense industry, leading to cost savings.

In addition, the present disclosure allows for the direct fabrication of complex components without the need for assembly or multiple processing steps, significantly reducing production time and costs. This is particularly beneficial for rapid prototyping and time-sensitive defense system development.

Moreover, the present disclosure ensures that defense components can withstand extreme temperatures without performance degradation, enhancing component reliability. By protecting components from thermal damage, it extends the lifespan of high-temperature-exposed parts, ultimately reducing maintenance and replacement costs over time.

### BRIEF DESCRIPTION OF THE DRAWINGS

FIG. 1 is a schematic diagram of a thermally retarded structure for components applied in high temperature environments according to an exemplary embodiment of the present disclosure.

FIG. 2 is an enlarged perspective view of the heat retarding unit in the thermally retarded structure for components applied in high temperature environments according to an exemplary embodiment of the present disclosure.

FIG. 3 is a schematic diagram of a thermally retarded structure for components applied in high temperature environments according to another exemplary embodiment of the present disclosure.

FIG. 4 is a diagram illustrating the detailed process flow of a method of manufacturing a thermally retarded structure for components applied in high temperature environments according to an exemplary embodiment of the present disclosure.

### DETAILED DESCRIPTION OF THE DISCLOSURE

Before describing the present disclosure in detail, the terms or words used in this specification should not be construed as being unconditionally limited to their ordinary or dictionary meanings, and in order for the inventor of the present disclosure to describe his/her disclosure in the best way, concepts of various terms may be appropriately defined and used, and furthermore, the terms or words should be construed as means and concepts which are consistent with a technical idea of the present disclosure.

That is, the terms used in this specification are only used to describe preferred embodiments of the present disclosure, and are not used for the purpose of specifically limiting the contents of the present disclosure, and it should be noted that the terms are defined by considering various possibilities of the present disclosure.

Further, in this specification, it should be understood that, unless the context clearly indicates otherwise, the expression in the singular may include a plurality of expressions, and similarly, even if it is expressed in plural, it should be understood that the meaning of the singular may be included.

In the case where it is stated throughout this specification that a component “includes” another component, it does not exclude any other component, but may further include any other component unless otherwise indicated.

Furthermore, it should be noted that when it is described that a component “exists in or is connected to” another component, this component may be directly connected or installed in contact with another component, and in inspect to a case where both components are installed spaced apart from each other by a predetermined distance, a third component or means for fixing or connecting the corresponding component to the other component may exist, and the description of the third component or means may be omitted.

On the contrary, when it is described that a component is “directly connected to” or “directly accesses” to another component, it should be understood that the third element or means does not exist.

Similarly, it should be construed that other expressions describing the relationship of the components, that is, expressions such as “between” and “directly between” or “adjacent to” and “directly adjacent to” also have the same purpose.

In addition, it should be noted that if terms such as “one side surface”, “other side surface”, “one side”, “other side”, “first”, “second”, etc., are used in this specification, the terms are used to clearly distinguish one component from the other component and a meaning of the corresponding component is not limited used by the terms.

Further, in this specification, if terms related to locations such as “upper”, “lower”, “left”, “right”, etc., are used, it should be understood that the terms indicate a relative location in the drawing with respect to the corresponding component and unless an absolute location is specified for their locations, these location-related terms should not be construed as referring to the absolute location.

Further, in this specification, in specifying the reference numerals for each component of each drawing, the same component has the same reference number even if the component is indicated in different drawings, that is, the same reference number indicates the same component throughout the specification.

In the drawings attached to this specification, a size, a location, a coupling relationship, etc. of each component constituting the present disclosure may be described while being partially exaggerated, reduced, or omitted for sufficiently clearly delivering the spirit of the present disclosure, and thus the proportion or scale may not be exact.

Further, hereinafter, in describing the present disclosure, a detailed description of a configuration determined that may unnecessarily obscure the subject matter of the present disclosure, for example, a detailed description of a known technology including the prior art may be omitted.

Hereinafter, exemplary embodiments of the present disclosure will be described in detail with reference to related drawings.

For structures such as drive shafts exposed to high temperatures and loads, material property degradation due to temperature increase may occur, potentially preventing the component from meeting its target performance. In such cases, delaying heat transfer to the load-bearing structure from the drive shaft can help prevent material degradation and contribute to achieving the desired performance.

Accordingly, the present disclosure proposes a novel structure and a manufacturing method of the novel structure, which delays heat transfer to the supporting structure through a thermally retarded structure including flow channels or pores.

In addition, the layered manufacturing process of 3D printing enables the creation of microscopic spaces within the internal structure. Based on this concept, the present disclosure proposes a novel structure and a manufacturing method of the novel structure, which forms a load-bearing structure including flow channels or pores, minimizing the surface area of the heat transfer path and delaying heat conduction to the supporting structure.

Hereinafter, heat retardation or heat delay refers to the delay in heat transfer from a heat source within the structure of a component.

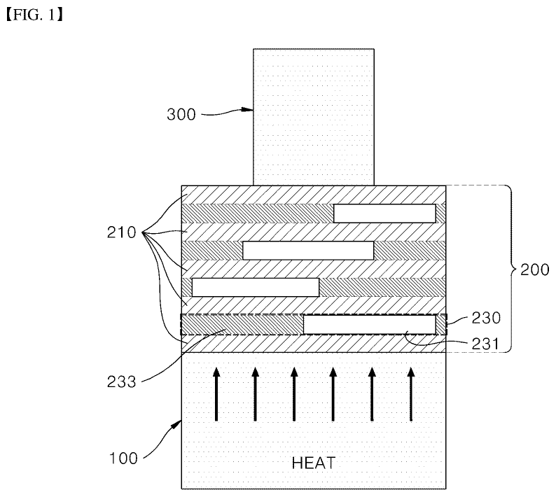

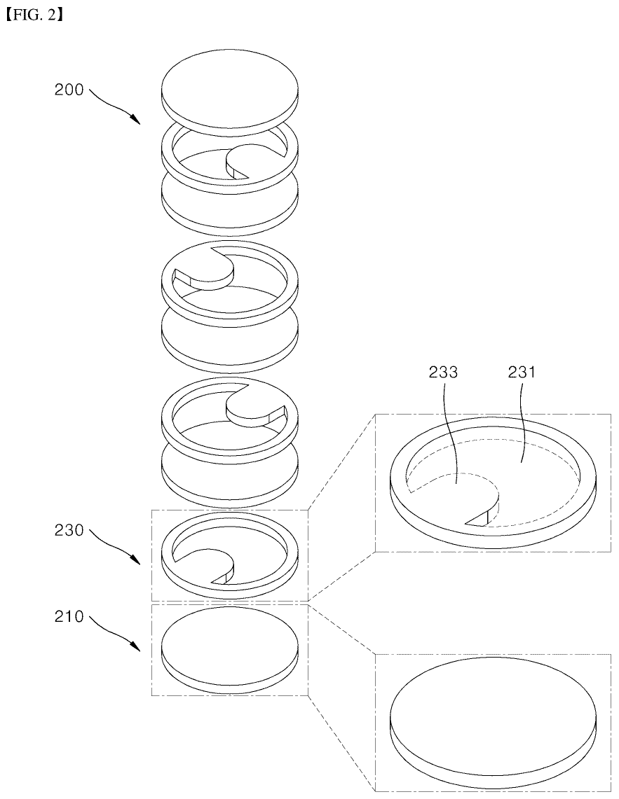

FIG. 1 is a schematic diagram of a thermally retarded structure for components applied in high temperature environments according to an exemplary embodiment of the present disclosure, and FIG. 2 is an enlarged perspective view of the heat retarding unit 200 in the thermally retarded structure for components applied in high temperature environments according to an exemplary embodiment of the present disclosure.

As shown in FIG. 1, the thermally retarded structure for components applied in high temperature environments according to an exemplary embodiment of the present disclosure may include a drive shaft body 100, a heat retarding unit 200, and a drive connection unit 300.

Here, the drive shaft body 100 may be the main body of a drive shaft, where a heat source may be generated due to the high speed operation in high temperature environments, such as in a projectile.

In addition, as shown in FIG. 1, the heat retarding unit 200, which is a key component of the present disclosure, may include a heat retarding layer 230 having a pore structure, where a plurality of the heat retarding layers 230 is formed being spaced apart from one another in the axial direction of the drive shaft body 100. The heat retarding unit 200 may also include a filling layer 210 that is positioned between the heat retarding layers 230 and serves as a heat transfer medium.

Further, the drive unit or the drive connection unit 300 may be a component such as a bearing assembly unit, which is axially connected to the heat retarding unit 200.

As illustrated in FIG. 1, the thermally retarded structure for components applied in high temperature environments according to an exemplary embodiment of the present disclosure provides a component structure in which the heat retarding unit 200 includes alternating layers of the heat retarding layer 230 with a pore structure and the filling layer 210 using 3D printing techniques. This structure is particularly beneficial for components such as the drive shaft and the bearing assembly unit of a projectile, which are exposed to high-temperature environments. By maximizing the heat transfer path through the stacked heat retarding unit 200, which is difficult to manufacture using conventional methods but can be realized with the 3D printing techniques, the present disclosure effectively delays heat transfer and provides an optimized thermally retarded component structure for high temperature environments.

In particular, the thermally retarded structure may be an internal drive structure of a lateral thruster responsible for attitude control of a projectile.

The internal drive structure of a lateral thruster responsible for the attitude control of a projectile may be a component that performs thrust control by opening and closing a flame gas nozzle at high temperature and high pressure.

In addition, the drive unit or the drive connection unit 300 may be a bearing assembly unit having a bearing and configured to operate with the bearing.

The heat retarding layer 230 may include a pore structure pattern 231 having a pre-designed shape and a pattern reinforcement structure 233 configured to enhance the rigidity of the heat retarding layer 230.

Here, the pore structure pattern 231 may be designed based on at least one design element selected from a group consisting of material, stacking order, shape, pattern size, outer wall thickness, and single pattern height, in order to correspond to a pre-designed heat transfer distance and structural rigidity.

In addition, the heat retarding layer 230 and the filling layer 210 may be formed by stacking in a direction of a drive shaft using the 3D printing technique.

Further, the heat retarding layer 230 and the filling layer 210 may be stacked using the 3D printing technique. Here, stacking order, spacing, shape, size, and thickness of the heat retarding layer 230 and the filling layer 210 may be designed to correspond to a pre-determined structural rigidity of the drive shaft.

In addition, the positions of the pore structure pattern 231 and the pattern reinforcement structure 233 in each layered heat retarding layer 230 formed within the heat retarding unit 200 can be set differently from one another, thereby extending and complicating the heat transfer path, enhancing the heat transfer delaying performance.

As shown in FIG. 1, the thermally retarded structure includes a drive shaft body 100, a heat retarding unit 200 including a filling layer 210 and a heat retarding layer 230, and a drive connection unit 300.

The drive shaft body 100 or shaft structure serves as the primary structural component where the heat source is introduced.

The filling layer 210 is a structure filled with bulk material in the heat retarding pattern, which determines the shape and rigidity of the structure while also allowing heat transfer through its layer.

The heat retarding layer 230 includes a pore structure pattern (heat retarding pattern) 231 and a pattern reinforcement structure 233. The pore structure pattern 231 may be designed with a void space, such as a pore. As the heat transferred through the drive shaft body 100 may follow an extended path within the pore structure pattern 231, the heat transfer can be delayed.

The pattern reinforcement structure 233 may partially fill the heat retarding layer 230 to enhance structural rigidity. The pattern reinforcement structure 233 serves to reinforce the strength of the heat retarding layer 230 and can be designed to maintain shape and support structural loads.

As described above, the heat retarding layer 230 may incorporate pores, insulation materials, or other heat transfer delaying elements along the heat conduction path, thereby increasing the heat transfer distance.

Additionally, the drive unit or drive connection unit 300 may be a bearing mounting unit or bearing assembly unit, where relative motion occurs at the interface with the drive structure. Since thermal expansion due to high temperature exposure can lead to seizure between the bearing and its mounting section, when the thermally retarded structure is internally applied, it can help prevent seizure caused by thermal expansion.

FIG. 2 is an enlarged view of the heat retarding unit 200 in the thermally retarded structure for components applied in high temperature environments, according to an exemplary embodiment of the present disclosure.

As shown in FIG. 2, the heat retarding unit 200 may be formed as an alternating stacked structure of the heat retarding layers 230 and the filling layers 210. By utilizing various combinations of the filling layers 210 and the heat retarding layers 230, heat transfer from the drive shaft body 100 to the drive unit or drive connection unit 300 can be delayed.

The heat delay effect can be adjusted by modifying parameters such as the shape, size, stacking order, and pattern length of the heat retarding layer 230. In addition, the thermally retarded structure can be pre-designed and fabricated using 3D printing techniques, allowing it to be tailored to meet the heat resistance and rigidity requirements of the specific component being applied.

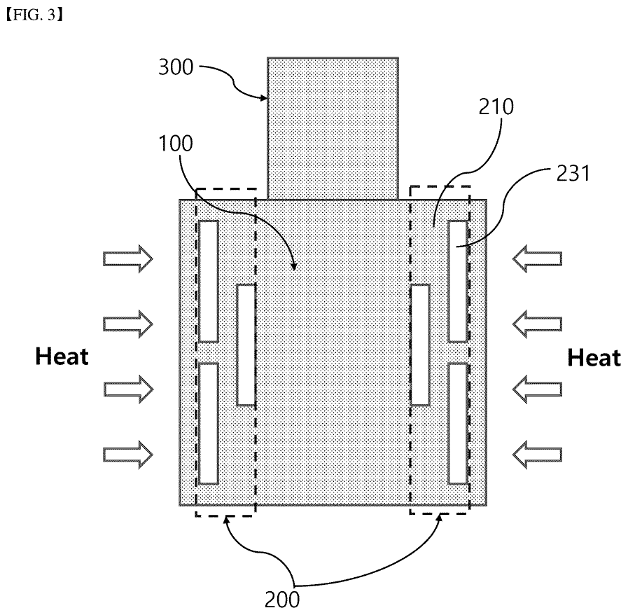

FIG. 3 is a schematic diagram of a thermally retarded structure for components applied in high temperature environments according to another exemplary embodiment of the present disclosure.

As shown in FIG. 3, the thermally retarded structure for components applied in high temperature environments according to another exemplary embodiment of the present disclosure may include a drive shaft body, a heat retarding unit, and a drive connection unit.

Here, unlike the exemplary embodiment shown in FIG. 1, the heat retarding unit may be structured such that the heat retarding layers are not formed in alignment with the drive shaft direction, where the heat source is introduced. Instead, the heat retarding layers, each of which includes a pore structure pattern, may be spaced apart from one another, in correspondence to the direction of heat input from the lateral surface.

The heat retarding unit, which includes heat retarding layers and filling layers, is formed using 3D printing techniques. It is preferable that the stacking order, spacing, shape, size, and thickness of the heat retarding layers and filling layers are designed to correspond to the predetermined structural rigidity of the drive shaft.

That is, as in the exemplary embodiments of FIGS. 1 and 3, the pore structure pattern can be formed in a way that effectively induces heat retardation in alignment with the direction in which the heat source is introduced. Furthermore, the dimensions such as spacing, shape, size, and thickness of the pattern can be optimized to maintain the targeted structural rigidity while achieving the desired heat transfer delay.

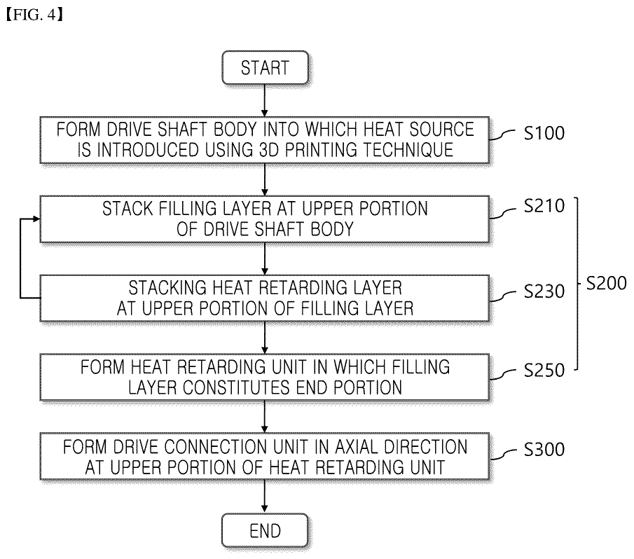

FIG. 4 is a diagram illustrating the detailed process flow of a method of manufacturing a thermally retarded structure for components applied in high temperature environments according to an exemplary embodiment of the present disclosure.

As shown in FIG. 4, the method of manufacturing a thermally retarded structure for components applied in high temperature environments according to an exemplary embodiment of the present disclosure is based on a 3D printing technique.

The method comprises steps of: (a) stacking a drive shaft body 100 into which a heat source is introduced (S100); (b) forming a heat retarding unit 200 including a plurality of heat retarding layers having a pore structure and a filling layer formed between the plurality of heat-retarding layers to facilitate heat transfer, wherein each of the plurality of heat retarding layers is spaced apart from one another in correspondence with a direction in which the heat source is introduced into the drive shaft body (S200); and (c) forming a drive connection unit 300 in an axial direction at an upper portion of the heat retarding unit 200 (S300). Here, the heat retarding unit 200 may be formed by alternately stacking each of the plurality of heat retarding layers with a pore structure pattern and the filling layer inside the drive shaft body.

In particular, the step (a) (S100) may involve stacking the drive shaft body 100 using a 3D printing technique. That is, step (a) (S100) refers to the process of stacking the drive shaft body 100 where the heat source is introduced. The drive shaft body 100 serves as the foundation of the thermally retarded structure and is the first part exposed to heat in a high-temperature environment.

It is preferable that the material of the drive shaft body 100 is selected to withstand high temperatures and provide structural stability.

The step (b) (S200) refers to a process of forming the heat retarding unit 200 using the 3D printing technique. The step (b) (S200) may comprise steps of: (b1) stacking the filling layer 210 in an axial direction at an upper portion of the drive shaft body 100 (S210); (b2) stacking the heat retarding layer 230 including the pore structure pattern 231 and a pattern reinforcement structure 233 at an upper portion of the filling layer 210 (S230); and (b3) repeating the steps (b1) and (b2) to form the heat retarding unit 200 in which the filling layer 210 constitutes an end portion of the heat retarding unit 200 (S250).

Here, step (b1) (S210) refers to the stacking process of the filling layer 210, in which the filling layer 210 is stacked in the axial direction at an upper portion of the drive shaft body 100. The filling layer 210 serves to regulate heat transfer between the heat retarding layers 230 while also providing structural strength.

The step (b2) (S230) refers to the stacking process of the heat retarding layer 230. Here, the heat retarding layer 230 including the pore structure pattern 231 and the pattern reinforcement structure 233 is stacked. That is, the heat retarding layer 230, which includes the pore structure pattern 231 and the pattern reinforcement structure 233, is stacked at an upper portion of the filling layer 210.

The heat retarding layer 230 functions to delay the direct transfer of heat and enhance structural strength.

In addition, in order to form the pore structure pattern 231, factors such as heat transfer distance, structural rigidity, material, stacking order, shape, pattern size, outer wall thickness, and single pattern height may be considered in its design.

In addition, the pattern reinforcement structure 233 located in the heat retarding layer 230 increases the structural strength of the heat retarding layer 230. This not only prevents deformation or damage to the heat retarding layer 230 due to heat exposure in high temperature environments but also aids in heat dispersion within the heat retarding layer 230, thereby enhancing the heat delay effect.

Subsequently, the step (b3) (S250) involves repeating the alternating stacking of the filling layer 210 and the heat retarding layer 230, as described in steps (b1) (S210) and (b2) (S230), to form the heat retarding unit 200. This process is carried out throughout the entire heat retarding unit 200 to complicate the heat transfer path, effectively delaying heat transmission. Here, the filling layer 210 may constitute each of end portions of the heat retarding unit 200.

As described above, by alternately stacking the heat retarding layer 230 and the filling layer 210, the heat transfer path becomes more complex, preventing heat from being rapidly transmitted in a direct manner. In this structure, heat must repeatedly change direction while passing through each of the multiple layers. It increases the heat transfer time and, as a result, reduces the amount of heat that reaches the internal drive components.

As shown in FIG. 4, the step (c) (S300) may refer to formation of the drive connection unit 300 in an upper axial direction of the heat retarding unit 200 using a 3D printing technique. The drive connection unit 300 serves to connect the drive shaft body 100 and the heat retarding unit 200 to the drive unit or drive component, such as a bearing assembly unit or other structural components.

The method for manufacturing a thermally retarded structure for components applied in high temperature environments according to an exemplary embodiment of the present disclosure is designed to protect components and maintain performance in high temperature environments. By leveraging 3D printing technology, it enables the precise fabrication of complex structures while allowing for effective management of the heat transfer path through the alternating stacking of heat retarding layers 230 and filling layers 210.

In addition, the method for manufacturing a thermally retarded structure for components applied in high-temperature environments, according to an embodiment of the present disclosure, ensures the stable operation of critical components, such as lateral thrusters in projectiles. By utilizing 3D printing technology, this method enables the precise fabrication of complex structures, thereby providing a component structure that maintains performance and durability even in high temperature environments.

The thermally retarded structure for components applied in high-temperature environments and its manufacturing method according to the present disclosure provide the following advantages:

### 1) Enhanced Thermal Protection

The thermally retarded structure increases the length of the heat transfer path, effectively delaying the time it takes for heat to reach heat-sensitive components. When applied to projectiles, the thermally retarded structure can be particularly useful for missile and projectile systems, which experience rapid temperature fluctuations during launch or flight.

In addition, by integrating low thermal conductivity materials into the thermally retarded structure, the heat flow to critical components can be minimized, ensuring that components operate within their temperature tolerance limits.

### 2) Improved Structural Integrity

As described in an exemplary embodiment of the present disclosure, incorporating a pattern reinforcement structure into the heat retarding layer 230 not only improves thermal management but also enhances the mechanical strength of the component. This dual functionality is particularly important in the defense industry, where components are subjected to extreme operational stress beyond simple thermal loads.

In addition, the heat retarding structure can be designed with specific materials, shapes, and layer configurations, allowing thermal and structural properties to be optimized based on the unique requirements of each application.

### 3) Manufacturing Precision

As demonstrated in an exemplary embodiment of the present disclosure, by utilizing 3D printing technology, it is possible to create complex geometries that are difficult or impossible to achieve using conventional manufacturing methods.

Furthermore, this precision is essential for components in the defense industry, where every detail can impact performance and reliability.

The manufacturing process allows for detailed control over material composition, thickness, and shape at each layer. This level of customization is highly effective in fine-tuning the thermal and mechanical properties of components to meet specific operational requirements.

### 4) Cost and Time Efficiency

Since 3D printing is an additive manufacturing process, it only uses material where necessary, leading to less waste compared to subtractive manufacturing methods. This is especially advantageous when using expensive materials commonly found in the defense industry, resulting in cost savings.

In addition, complex components can be directly manufactured without assembly or multiple processing steps, significantly reducing production time and costs. This is particularly beneficial for rapid prototyping and time-sensitive defense system development.

### 5) Operational Reliability

The thermally retarded structure according to the present disclosure ensures that defense components can withstand extreme temperatures without performance degradation, thereby enhancing component reliability.

Furthermore, by protecting components from thermal damage, the thermally retarded structure extends the lifespan of components exposed to high temperature, ultimately reducing maintenance and replacement costs over time.

In the above, although several preferred embodiments of the present disclosure have been described with some examples, the descriptions of various exemplary embodiments described in the “Specific Content for Carrying Out the Invention” item are merely exemplary, and it will be appreciated by those skilled in the art that the present disclosure can be variously modified and carried out or equivalent executions to the present disclosure can be performed from the above description.

In addition, since the present disclosure can be implemented in various other forms, the present disclosure is not limited by the above description, and the above description is for the purpose of completing the disclosure of the present disclosure, and the above description is just provided to completely inform those skilled in the art of the scope of the present disclosure, and it should be known that the present disclosure is only defined by each of the claims.

### LIST OF REFERENCE NUMBERS

100: drive shaft body
200: heat retarding unit
210: filling layer
230: heat retarding layer
231: pore structure pattern
233: pattern reinforcement structure
300: drive connection unit

What is claimed is:

1. A thermally retarded structure for components applied in high temperature environments, comprising:
a drive shaft body into which a heat source is introduced;
a heat retarding unit including a plurality of heat retarding layers having a pore structure and a filling layer formed between the plurality of heat-retarding layers to facilitate heat transfer, wherein each of the plurality of heat retarding layers is spaced apart from one another in correspondence with a direction in which the heat source is introduced into the drive shaft body; and
a drive connection part axially connected to the heat retarding unit.

2. The thermally retarded structure of claim 1,
wherein the drive connection unit is a bearing assembly unit configured to operate with a bearing.

3. The thermally retarded structure of claim 1,
wherein the thermally retarded structure is an internal drive structure of a lateral thruster responsible for attitude control of a projectile.

4. The thermally retarded structure of claim 1,
wherein the heat retarding layer includes:
a pore structure pattern having a pre-designed shape; and
a pattern reinforcement structure configured to enhance the rigidity of the heat retarding layer.

5. The thermally retarded structure of claim 4,
wherein the pore structure pattern is designed based on at least one design element selected from a group consisting of material, stacking order, shape, pattern size, outer wall thickness, and single pattern height, in order to correspond to a pre-designed heat transfer distance and structural rigidity.

6. The thermally retarded structure of claim 1,
wherein the heat retarding layer and the filling layer are formed by stacking in a direction of a drive shaft using a 3D printing technique.

7. The thermally retarded structure of claim 6,
wherein the heat retarding layer and the filling layer are stacked using the 3D printing technique, and
wherein stacking order, spacing, shape, size, and thickness of the heat retarding layer and the filling layer are designed to correspond to a pre-determined structural rigidity of the drive shaft.

8. A method of manufacturing a thermally retarded structure for components applied in high temperature environments based on a 3D printing technique, the method comprising steps of:
(a) stacking a drive shaft body into which a heat source is introduced;
(b) forming a heat retarding unit including a plurality of heat retarding layers having a pore structure and a filling layer formed between the plurality of heat-retarding layers to facilitate heat transfer, wherein each of the plurality of heat retarding layers is spaced apart from one another in correspondence with a direction in which the heat source is introduced into the drive shaft body, and wherein the heat retarding unit is formed by alternately stacking each of the plurality of heat retarding layers with a pore structure pattern and the filling layer inside the drive shaft body; and
(c) forming a drive connection unit in an axial direction at an upper portion of the heat retarding unit.

9. The method of claim 8,
wherein the step (b) comprises steps of:
(b1) stacking the filling layer in an axial direction at an upper portion of the drive shaft body;
(b2) stacking the heat retarding layer including the pore structure pattern and a pattern reinforcement structure at an upper portion of the filling layer; and
(b3) repeating the steps (b1) and (b2) to form the heat retarding unit in which the filling layer constitutes an end portion of the heat retarding unit.

10. The method of claim 8,
wherein, in the step (b), the heat retarding layer and the filling layer are stacked using the 3D printing technique to form the heat retarding unit, and
wherein stacking order, number, spacing, shape, size, and thickness of the heat retarding layer and the filling layer are designed to correspond to a pre-determined structural rigidity of the drive shaft.

11. The method of claim 8,
wherein the pore structure pattern is designed based on at least one design element selected from a group consisting of material, stacking order, shape, pattern size, outer wall thickness, and single pattern height, in order to correspond to a pre-designed heat transfer distance and structural rigidity.

12. A thermally retarded structure for components applied in high temperature environments, characterized by being manufactured by the method of claim 8.

13. The thermally retarded structure of claim 12, characterized by being used in an internal drive structure of a lateral thruster responsible for attitude control of a projectile.
